(19) United States
(12) Patent Application Publication
(10) Pub. No.: US 2023/0030440 A1
(43) Pub. Date: Feb. 2, 2023

(54) OVERMOLDED TRANSPARENT STRUCTURE

(71) Applicant: DOW GLOBAL TECHNOLOGIES LLC, Midland, MI (US)

(72) Inventor: Xuejun Liu, Shanghai (CN)

(21) Appl. No.: 17/754,220

(22) PCT Filed: Nov. 1, 2019
(86) PCT No.: PCT/CN2019/115013

§ 371 Date: Mar. 28, 2022

(51) Int. Cl. B44C 5/06; B44C 5/00

(52) U.S. Cl. CPC B44C 5/06; B44C 5/005

(57) ABSTRACT

A transparent injection overmolded structure (100) encapsulating a real botanical matter (70) including at least one first transparent multilayer film member (50), at least one second transparent multilayer film member (60), a real botanical matter (70) disposed and encapsulated between the surface of the first transparent multilayer film member (50) and the surface of the second transparent multilayer film member (60) forming an integral transparent multilayered encapsulation structure (30), a base member (40) for receiving and attaching to the transparent multi-layered encapsulation structure (30), and an injection overmolded transparent plastic member (20) integral with and enveloping the base member (40) and the transparent multilayered encapsulation structure (30). Wherein the at least one first transparent multilayer film (50) member includes at least one low-seal initiation temperature inner layer (51) for contacting a botanical matter (70), at least one outer bonding layer (52) for contacting and bonding to an injection overmolded transparent plastic member (20), and at least one core barrier layer (53) interposed between the inner layer (51) and outer layer (52); wherein the at least one second transparent multilayer film member (60) includes at least one low-seal initiation temperature inner layer (61) for contacting a botanical matter (70), at least one outer bonding layer (62) for contacting and bonding to an injection overmolded transparent plastic member (20), and at least one core barrier layer (63) interposed between the inner layer (61) and outer layer (62). A process for producing the transparent injection overmolded structure (100) encapsulating a real botanical matter (70) is also disclosed.

### FIELD

The present invention is related to an injection overmold structure and a process for manufacturing said overmold structure. More specifically, the present invention is related to an injection overmolded transparent structure having a real botanical matter such as plants, trees, or parts thereof such as leaves, flowers, petals, seeds, and fruits encapsulated therein; and an injection overmolding process for making an injection overmolded transparent structure having a real botanical matter encapsulated in the overmolded structure.

### BACKGROUND

It is common to encapsulate a decorative synthetic, artificial or imitation leaf or flower in a transparent structure by using an injection overmolding process. It is also known to use an injection molding process to completely seal a dried and pressed flower using a film having a low melting point wherein the flower is in a substantially absolutely dried state and in a state free from air and moisture as described in U.S. Pat. No. 5,662,970. Using the known injection molding process of U.S. Pat. No. 5,662,970, it is possible to obtain a sealed transparent ornament of a dried and pressed flower such that the flower does not discolor or fade for a long period of time.

Other injection molding processes are disclosed in, for example, (1) U.S. Pat. No. 8,334,033 which discloses an injection molded article produced by an over molding process, using a sodium/zinc ionomer composition as the substrate material, the over-mold material or both; (2) U.S. Pat. No. 9,987,778 which discloses producing an in-mold decoration (“IMD”) using an overmolding process that completely encapsulates and hermetically seals the IMD layer; and (3) EP1504872A1 which discloses a container wall and base areas that are covered by a diffusion barrier film which is placed in an injection molding tool with a decorative film.

None of the above prior art references discloses, and heretofore no process has been developed for, successfully encapsulating a real, fresh tree leaf, flower, petal or other botanical material in a transparent structure by using an injection overmolding process. Most known processes are carried out under process conditions, such as high temperature (e.g. >180° C.) that would damage a real botanical material. It is desired, therefore, to provide an injection overmolding process and an overmold structure made using the injection overmolding process for encapsulating a real, fresh botanical matter, material, item, or article, such as a tree leaf, flower or flower petal, by using an injection overmolding process.

### SUMMARY

One embodiment of the present invention is directed to a transparent injection overmolded structure encapsulating a real botanical matter including: (a) at least one first transparent multilayer film member; wherein the at least one first transparent multilayer barrier film member includes: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer; (b) at least one second transparent multilayer film member; wherein the at least one second transparent multilayer barrier film member includes: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer; (c) a real botanical matter disposed and encapsulated inbetween the surface of the first transparent multilayer film member and the surface of the second transparent multilayer film member forming an integral transparent multilayered encapsulation structure; (d) a base member for receiving and attaching to the transparent multilayered encapsulation structure of component (c); and (e) an injection overmolded transparent plastic member integral with, and enveloping, the base member of component (d) and the transparent multilayered encapsulation structure of component (c) for forming an overmolded transparent part encapsulating a real botanical matter inside the part.

Another embodiment of the present invention is directed to an injection overmolding process for preparing the above transparent injection overmolded structure encapsulating a real botanical matter including the steps of: (A) providing at least one first transparent multilayer film member; wherein the at least one first transparent multilayer barrier film member includes: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer; (B) providing at least one second transparent multilayer film member; wherein the at least one second transparent multilayer barrier film member includes: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer; (C) providing a real botanical matter (D) interposing and encapsulating the real botanical matter in between the surface of the first transparent multilayer film member and the surface of the second transparent multilayer film member forming an integral transparent multilayered encapsulation structure; (E) providing a base member for receiving and attaching to the transparent multilayered encapsulation structure of step (D); (F) attaching the transparent multilayered encapsulation structure of step (D) onto the surface of the base member of step (E); (G) placing the combination of the transparent multilayered encapsulation structure attached to the surface of the base member of step (F) into an injection mold; and (H) overmolding by injection molding a transparent plastic member onto the combination of the transparent multilayered encapsulation structure attached to the surface of the base member positioned in the injection mold of step (G) to form an overmolded transparent part encapsulating a real botanical matter inside the part.

In a preferred embodiment, the present invention includes an injection overmold structure or part encapsulating a real botanical matter, item, material or article such as a real tree leaf, flower or flower petal, wherein the overmold structure is produced by the above injection overmolding process.

In another preferred embodiment, the present invention includes an injection overmolding process for encapsulating a real botanical matter, item, material or article such as a real tree leaf, flower or flower petal.

The process of the present invention includes, for example, a novel decoration product and a process for manufacturing such product and/or a package for such product. For example, a picture, a label, a painting/printing, or a hot stamping indicium can be used in the injection overmolding and encapsulating process of the present invention. And, the unique process of the present invention has several advantages compared to known injection overmolding processes for encapsulating a decorative synthetic article such as a synthetic leaf or flower picture. For example, in the process of encapsulating a real, fresh leaf or flower can reduce lacquer and ink usage in the process of encapsulating a decorative synthetic leaf or flower picture. Other advantages of using the unique and novel decoration process of the present invention for encapsulating a real fresh leaf or flower also include, for example, the process provides: (1) a healthy and safe product, (2) an environment friendly process; and (3) an outstanding product image.

### BRIEF DESCRIPTION OF THE DRAWINGS

FIG. 1 is a perspective view of a transparent overmolded structure having a real tree leaf encapsulated in the transparent overmolded structure, the structure being made by using an injection overmolding process.

FIG. 2 is a perspective view of a combination structure of an integral transparent multilayered encapsulation structure and a base member having a real tree leaf encapsulated in the transparent multilayered encapsulation structure, without an injection overmolded transparent plastic member.

FIG. 3 is a perspective, partly exploded, view of the combination structure of FIG. 2.

FIG. 4 is a side cross-sectional, partly exploded, view of the integral transparent multilayered encapsulation structure 30 of FIG. 3.

FIG. 5 is side cross-sectional exploded view of the integral transparent multilayered encapsulation structure 30 of FIG. 4 showing the film structure of the first transparent multilayer film member, the second transparent multilayer film member, and the leaf of FIG. 4.

FIG. 6 is a side cross-sectional view of the transparent overmolded structure having a real tree leaf encapsulated in the transparent overmolded structure taken along line 6-6 of FIG. 1.

FIG. 7 is a schematic process flow chart of an injection overmolding process for fabricating the transparent overmolded structure having a real tree leaf encapsulated in the transparent overmolded structure of FIG. 6.

### DETAILED DESCRIPTION

As used throughout this specification, the abbreviations given below have the following meanings, unless the context clearly indicates otherwise: “=” means “equal to”; @ means “at”; g=gram(s); mg=milligram(s); kg=kilograms; kg/m3=kilograms per cubic meter; L=liter(s); mL=milliliter(s); g/L=grams per liter; rpm=revolutions per minute; Mw=molecular weight; m=meter(s); μm=microns: μL=microliters; mm=millimeter(s); cm=centimeter(s); cc=cm3; g/cc=gram(s) per cubic centimeter; min=minute(s); s=second(s); hr=hour(s); ° C.=degree(s) Celsius; mPa·s=millipascals-seconds; kPa=kilopascals; Pa·s/m2=pascals-seconds per meter squared; mg KOH/g=hydroxyl value in terms of milligrams of potassium hydroxide per gram of polyol; cells/mm2 is pore density value in terms of the number of cells per millimeter squared; %=percent, vol %=volume percent; and wt %=weight percent.

All percentages stated herein are weight percentages (wt %), unless otherwise indicated.

Temperatures are in degrees Celsius (° C.), and “ambient temperature” means between 20° C. and 25° C., unless specified otherwise.

“Botanical matter” is used herein in a broad scope to refer to and include agricultural, floral, horticultural, flora, plant, vegetation, herbs, vegetables, other botanic matter, and any parts thereof.

One broad embodiment of the present invention includes a transparent injection overmolded structure having a real botanical matter encapsulated in the transparent injection overmolded structure. The molded structure includes, for example, (a) at least one first transparent multilayer film member; (b) at least one second transparent multilayer film member; wherein the first and second transparent multilayer film layers have oxygen and/or moisture barrier functions; (c) a real botanical matter disposed, sandwiched and encapsulated in between the surface of the first transparent multilayer film member and the surface of the transparent second multilayer film member forming an integral transparent multilayered structure; (d) a base member for receiving the transparent multilayered structure of component (c); and (e) an injection overmolded transparent plastic member integral with, and enveloping both the base member of component (d) and the transparent multilayered structure of component (c). The resultant injection molded structure forms an encapsulated real botanical matter inside the overmolded transparent plastic member.

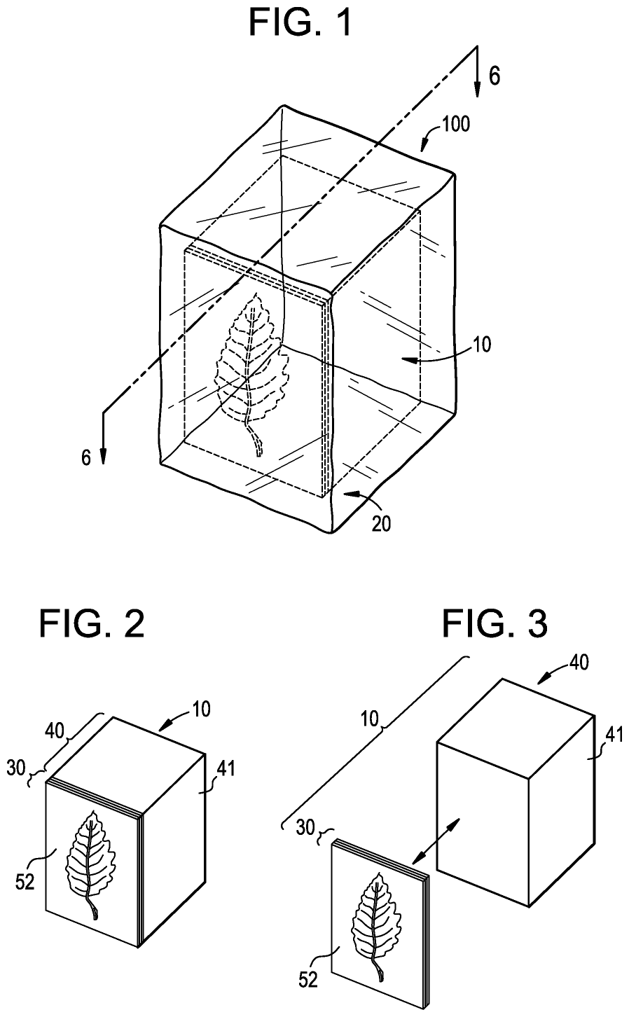

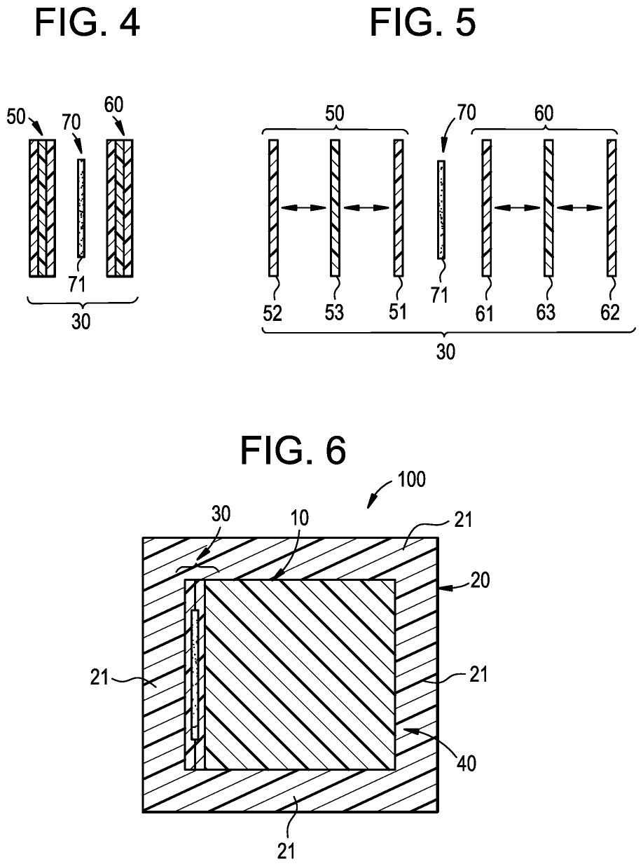

For example, with reference to FIGS. 1-7, there is shown a transparent injection overmolded structure, generally indicated by reference numeral 100 (e.g., as shown in FIGS. 1, 6 and 7) for encapsulating a real botanical matter, including a combination structure, generally indicated by reference numeral 10 overmolded with an injection overmolded transparent plastic member 20. The combination structure 10, shown in FIGS. 2 and 3, includes an integral transparent multilayered encapsulation structure, generally indicated by reference numeral 30; and a base member, generally indicated by reference numeral 40 integral with the structure 30. With reference to FIG. 4, the transparent multilayered encapsulation structure 30 includes a first transparent multilayer film member, generally indicated by reference numeral 50; a second transparent multilayer film member, generally indicated by reference numeral 60; and a botanical matter, generally indicated by reference numeral 70, such as a real tree leaf; the real tree leaf being sandwiched and encapsulated in between the first and second film members 50 and 60, respectively, to form the integral transparent multilayered encapsulation structure 30. The real botanical matter 71 is disposed, sandwiched, and encapsulated inbetween at least a portion of the surface of the first transparent multilayer film layer 50 and at least a portion of the surface of the transparent second multilayer film layer 60.

The botanical matter 70 shown in FIGS. 1-7, and herein described, is a tree leaf 71 for illustrative purposes only and not to be limited thereby. As described herein, the botanical matter 70 can include one real botanic item, such as a single tree leaf shown in FIGS. 1-7 in one embodiment; or the botanical matter 70 can include two or more real botanic items, such as a combination of a tree leaf, a flower pedal, and a plant leaf (not shown) in another embodiment. The base member 40 can include one single layer 41, as shown in FIGS. 2 and 3, of a transparent material and of any desired thickness; or the base member 40 can include two or more layers (not shown) of transparent materials and of any desired thickness.

With reference to FIG. 5, there is shown the integral transparent multilayered encapsulation structure 30 first transparent multilayer film member 50 of the integral transparent multilayered encapsulation structure 30 including the film member 50 which can be made up of a single layer in one embodiment (not shown), or two or more layers as shown in FIG. 5 in another embodiment; the second transparent multilayer film member 60 of the integral transparent multilayered encapsulation structure 30 which can be identical to, or different than, the first film member 50 and which can be made up of a single layer in one embodiment (not shown), or two or more layers as shown in FIG. 5 in another embodiment. The film member 50 and the film member 60 each include, for example, at least 3 layers as shown in FIG. 5. In a preferred embodiment shown in FIG. 5, the first transparent multilayer film member 50 includes, for example and not to be limited thereby, (i) a first layer comprising at least one low-seal initiation temperature inner layer 51 for contacting a botanical matter; (ii) a second layer comprising at least one outer bonding layer 52 for contacting and bonding to an injection overmolded transparent plastic member; and (iii) a third layer comprising at least one core barrier layer 53 interposed between the inner layer and the outer layer. The second film member 60 can be identical to the first film member 50 as shown in FIG. 5 in one embodiment. For example, the film member 60 includes at least 3 layers. In a preferred embodiment shown in FIG. 5, the second transparent multilayer film member 60 includes, for example and not to be limited thereby, (i) a first layer comprising at least one low-seal initiation temperature inner layer 61 for contacting a botanical matter; (ii) a second layer comprising at least one outer bonding layer 62 for contacting and bonding to an injection overmolded transparent plastic member; and (iii) a third layer comprising at least one core barrier layer 63 interposed between the inner layer and the outer layer. In FIG. 5, there is also shown a botanical matter 70 such as a leaf 71 interposed between the film members 50 and 60.

With reference to FIG. 6 there is shown a cross-sectional view of a complete assembly of a transparent injection overmolded structure 100 for encapsulating a real botanical matter, wherein the structure 100 includes a combination structure 10 overmolded with an injection overmolded transparent plastic member 20. In the embodiment shown in FIGS. 1-7, the first and second multilayer film members 50 and 60 with a leaf sandwiched between the two members forming structure 30 in combination with the base member 40 is overmolded with the transparent plastic member 20. The complete assembly of the transparent components 10-60 are attached to, and integral with, each other to make up the transparent injection molded structure 100 containing a real botanical matter 70 encapsulated therein. In some embodiments, when a non-sensitive botanical matter 70 is used as component 71, then barrier layers, components 53 and 63 of the film members 50 and 60, respectively, may be optional. The integral transparent multilayered encapsulation structure 30 (encapsulating the real botanical matter component 71) is attached to the base member 40 to form the combination structure 10 which, in turn, is overmolded by the transparent plastic member 20 to integrally envelope the combination structure 10 to form an injection overmolded transparent part encapsulating a real botanical matter 71 inside the part.

The first transparent film member useful in the present invention may include one layer or any number of layers. For example, the one or more layers comprising the first transparent film member may include sealing layers, barrier layers, tie layers, outer layers, or combinations thereof. In a preferred embodiment, the first film member is a multilayer film and comprises, for example, at least three layers including an inner layer, a core layer and an outer layer. In other embodiments, the first multilayer film member may include three or more layers in one embodiment, from 3 layers to 7 layers in another embodiment, from 3 layers to 6 layers in still another embodiment, and from 3 layers to 5 layers in yet another embodiment.

In a preferred embodiment, the first transparent multilayer film member includes, for example: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer. In another embodiment, an optional tie layer or an adhesive layer can be added to the surface of each side of the core barrier layer to bind the three layers (i)-(iii) together forming at least a five-layer first transparent multilayer film member.

In still another preferred embodiment, the layers making up the first transparent multilayer film member includes an oxygen barrier layer and a separate moisture barrier layer, the two different barrier layers, the inner layer and the outer layer are bonded together with, for example, a tie layer disposed inbetween each of the four layers described above forming at least a seven-layer first transparent multilayer film member. For example, the seven-layered structure of the first transparent multilayer film member includes: (i) at least one low-seal initiation temperature inner layer for contacting a botanical matter; (ii) at least one oxygen barrier layer; (iii) at least a first tie layer interposed between the at least one low-seal initiation temperature inner layer and the at least one oxygen barrier layer; (iv) at least one moisture barrier layer; (v) at least a second tie layer interposed between the at least one oxygen barrier layer and the at least one moisture barrier layer; (vi) at least one outer bonding layer for contacting and bonding to the injection overmolded transparent plastic member; and (vii) at least a third tie layer interposed between the at least one moisture barrier layer and the at least one outer bonding layer.

The sealing layer or “low-seal initiation temperature” inner layer, component (i) of the first transparent multilayer film member, is a high-performance sealant layer that is typically used in flexible packaging. The low-seal initiation temperature inner layer is made from, for example, ethylene-based polymers, ethylene alpha-olefin, copolymer of ethylene and (meth)acrylic acid, a modified ethylene acrylate, and mixtures of various ethylene alpha-olefins.

In some embodiments, the transparent film may include one or more sealing layers. Without being bound by theory, the one or more sealing layers may allow for the structure of the multilayer film to: (1) be heat sealable, (2) contain the product, and (3) protect one or more barrier layers. In general, the sealing layer should have a seal initiation temperature less than 150° C. in one embodiment. In other embodiments, the low-seal initiation temperature of the inner layer is from 60° C. to 120° C. in one embodiment, from 60° C. to 100° C. in another embodiment, and from 60° C. to 90° C. in still another embodiment.

In still another embodiment, an ethylene α-olefin copolymer is useful in the present invention. The ethylene α-olefin copolymer is a homogenously branched copolymer and is linear or substantially linear. The substantially linear ethylene/α-olefin interpolymers have long chain branching. The long chain branches have the same comonomer distribution as the polymer backbone, and can have about the same length as the length of the polymer backbone. The term “substantially linear,” with reference to a polymer, means a polymer that is substituted, on average, with “0.01 long chain branches per 1,000 carbons” to “3 long chain branches per 1,000 carbons.” The length of a long chain branch is longer than the carbon length of a short chain branch, formed from the incorporation of one comonomer into the polymer backbone.

In one generally embodiment, some polymers may be substituted with 0.01 long chain branches per 1,000 total carbons to 3 long chain branches per 1,000 total carbons, from 0.05 long chain branches per 1,000 total carbons to 2 long chain branch per 1,000 total carbons in another embodiment, and from 0.3 long chain branches per 1,000 total carbons to 1 long chain branch per 1,000 total carbons in still another embodiment.

The ethylene α-olefin copolymer useful in the present invention comprises greater than 50 mole percent by weight of units derived from ethylene. The ethylene α-olefin copolymers comprise from 5 mole percent by weight to 20 mole percent by weight of units derived from one or more α-olefin comonomers. Such α-olefin comonomers typically have no more than 20 carbon atoms. For example, the α-olefin comonomers may have 3 to 10 carbon atoms in one embodiment, and from 3 to 8 carbon atoms in another embodiment. Exemplary α-olefin comonomers useful in the present invention include, but are not limited to, propylene, 1-butene, 1-pentene, 1-hexene, 1-heptene, 1-octene, 1-nonene, 1-decene, 4-methyl-1-pentene, and mixtures thereof. The one or more α-olefin comonomers may be selected, for example, from the group consisting of propylene, 1-butene, 1-hexene, and 1-octene; or in the alternative, from the group consisting of 1-hexene and 1-octene.

Various commercial embodiments are considered suitable for the one or more sealing layers used in the present invention. In a preferred embodiment, for example, the material of the low-seal initiation temperature inner layer can include commercially available compounds such as AFFINITY™, a polyolefin plastomer (POP), or ELITE™, an ethylene-based polymer (both AFFINITY™ and ELITE™ are commercially available from The Dow Chemical Company); and NUCREL™, an ethylene-(meth)acrylic acid copolymer resin (commercially available from The Dow Chemical Company); and mixtures thereof. The low-seal initiation temperature inner layer such as AFFINITY™ is a heat-seal layer and this low heat-sealing temperature grade product is used to avoid damage to the botanical matter such as a leaf that is to be encapsulated during the heat-sealing process. In another preferred embodiment, the suitable sealing layers include AFFINITY™ and/or ELITE™.

The substantially linear ethylene/α-olefin interpolymer homogeneously branched copolymer useful in the present invention is also described, for example, in U.S. Pat. Nos. 5,272,236; 5,278,272; 6,054,544; 6,335,410 and 6,723,810.

The oxygen barrier layer, component (ii) of the first transparent multilayer film member, is also a transparent film and may include one or more oxygen barrier layers. In some embodiments, the oxygen barrier layer may include a polar polymer or a non-polar layer or combinations thereof. In a preferred embodiment, the moisture barrier layer is a polar polymer. The term “polar polymer,” as used herein, refers to polymer formed from at least one monomer that comprises at least one heteroatom. Some examples of heteroatoms include 0, N, P and S. In various embodiments, the polar polymer has a melt index (I2) (2.16 kg, 190° C.) of from 0.1 g/10 min to 40 g/10 min in one embodiment, from 0.2 g/10 min to 20 g/10 min in another embodiment, and from 0.5 g/10 min to 10 g/10 min in still another embodiment. In various embodiments, the polar polymer has a density from 0.80 g/cc to 1.30 g/cc in ne embodiment, and from 1.00 g/cc to 1.20 g/cc in another embodiment.

In some embodiment, the one or more oxygen barrier layers may include one or more layers of, for example, ethylene vinyl alcohol (EVOH) which is a copolymer of ethylene and vinyl alcohol; polyethylene terephthalate (PET), a polyamide (PA) and mixtures thereof. In a preferred embodiment, the oxygen barrier layer is a polar polymer selected, for example, from EVOH such as 25 Eval H171B (available from Kuraray) or a polyamide (PA) such as a nylon selected from the group consisting of Nylon 6, Nylon 66, and Nylon 6/66 (available from DuPont), and combinations thereof. In another preferred embodiment, the polar barrier layer comprises at least one layer of EVOH.

In general, the oxygen transmittance rate (OTR) of the oxygen barrier layer is from 0.002 cc-mm/[m²-day] to 2 cc-mm/[m²-day] in one embodiment; from 0.002 cc-mm/[m²-day] to

0.2 cc-mm/[m²-day] in still another embodiment, and from 0.002 cc-mm/[m²-day] to 0.02 cc-mm/[m²-day] in yet another embodiment. A botanical matter is more difficult to oxidize if the OTR is below 0.02 cc-mm/[m²-day], and a botanical matter is easier to oxidize if the OTR is above 2 cc-mm/[m²-day]. The OTR of the oxygen barrier layer is measured according to the test procedure described in ASTM D3985-02 using a test instrument such as MOCON OX-TRAN® 2/21 (available from MOCON Inc.); and using the following test parameters: temperature=23.0° C., humidity=0% RH, test area=50 cm², and number of cycles=4.

The moisture barrier layer, component (iv) of the first transparent multilayer film member, is also a transparent film and may include one or more moisture barrier layers. In some embodiment, the one or more moisture barrier layers may include one or more layers of, for example, polyamide (PA), polyethylene terephthalate (PET), polyethylene (PE), and mixtures thereof.

In other embodiments, the polymer material of the moisture barrier layer can include commercially available compounds. Various commercial embodiments considered suitable for the one or more moisture barrier layers, include, for example, ULTRAMID (available from BASF), EVAL (available from Kuraray), SARAN (available from SK Chemicals), and ELITE™ Enhanced Polyethylene (available from The Dow Chemical Company). In a preferred embodiment, the moisture barrier layer is, for example, ELITE™ Enhanced Polyethylene resin. A moisture barrier layer, such as ELITE™, is typically used in flexible plastic packaging and ELITE™ resins exhibit several good properties such as high impact strength, high stretch, high puncture resistance, high stiffness, and good sealability.

In general, the moisture transmittance rate (MTR) of the moisture barrier layer is from 0.1 gm-mm/[m²-day] to 10 gm-mm/[m²-day] in one embodiment, from 0.1 gm-mm/[m²-day] to

5 gm-mm/[m²-day] in still another embodiment, and from 0.1 gm-mm/[m²-day] to 0.5 gm-mm/[m²-day] in yet another embodiment. An encapsulated botanical matter is more difficult to wither if the MTR is below 10 gm-mm/[m²-day], and the encapsulated botanical matter is easier to wither if the MTR is above 10 gm-mm/[m²-day]. The MTR of the moisture barrier layer is measured according to the test procedure described in ASTM F1249 using the following test parameters: 37.8° C. and humidity 100% RH.

In addition to the moisture and oxygen barrier layers, optionally, one or more other barrier layers may be used in the present invention. For example, barrier layers that may aid in providing chemical resistance or prevent light transmission may be used in the present invention.

The outer bonding layer, component (vi) of the first transparent multilayer film member, is also transparent and a bonding layer used to bond with an overmolding ionomer material. The outer bonding layer is typically used in flexible packaging to provide good film optics, package appearance, and product visibility. In some embodiments, the transparent outer bonding film layer may include one or more outer layers. Without being bound by theory, the outer layer adheres to the ionomer used for overmolding.

In a general embodiment, the outer bonding layer used in the present invention may include an acid copolymer resin (ACR). ACRs of the present invention are copolymers of ethylene and at least one unsaturated carboxylic acid monomer, or a suitable derivative thereof, such as ester derivatives.

For example, the ACR suitable for use in the present invention can include a copolymer of ethylene a carboxylic acid, for example, either acrylic acid (AA) or methacrylic acid (MAA); half-esters of maleic anhydride including the mono ethyl ester (MAME) of maleic anhydride; a modified ethylene acrylate; and mixtures thereof. For the purposes of the present invention, the term “(meth)acrylic acid” as used herein is a shorthand notation to denote that any of these acids can be used either alone or in combination.

In a preferred embodiment, the material of the outer bonding layer can include commercially available compounds such as NUCREL™, an ethylene-(meth)acrylic acid copolymer resin (commercially available from The Dow Chemical Company); PRIMACOR (available from SK Chemicals); BYNEL™, an anhydride-modified, linear low-density polyethylene (LLDPE) resin, (commercially available from The Dow Chemical Company); modified ethylene acrylate resins; an anhydride-modified ethylene vinyl acetate polymers; an anhydride-modified; high-density polyethylene resins; an anhydride-modified polypropylene resins; an acid/acrylate-modified ethylene vinyl acetate polymers; an ethylene vinyl acetate polymers; and mixtures thereof.

The concentration of the ACR used in the present invention includes, for example, 10 wt % or less, based on the total weight of the polymer in one embodiment, from 10 wt % to 20 wt % in another embodiment, and from 20 wt % to 30 wt % in still another embodiment. Actual examples herein will refer to a specific acid, or a specific combination of acids. For example, ACRs of the present invention include from 5 wt % to 10 wt % (meth)acrylic acid in one embodiment, and from 10 wt % to 20 wt % (meth)acrylic acid in another embodiment.

In general, the bonding strength of the outer bonding barrier layer is proper if an overmolded part exhibits no delamination between the outer bonding layer and the injection overmold transparent plastic member after one month of storage at room temperature.

The aforementioned first, second and third tie layers, components (iii), (v) and (vii), respectively, of the first transparent multilayer film member, can be the same or each of the tie layers can be different. In a preferred embodiment, the first, second and third tie layers are identical since the same tie layer used is compatible with the other four layers, components (i), (ii), (iv) and (vi).

The tie layers adhere to polyolefin-based films and to one or more barrier layers. Each of the tie layers can be made from any one or more of the following polymer compounds: an anhydride-modified, linear low-density polyethylene (LLDPE) resin, an ethylene-(meth)acrylic acid copolymer resin, a modified ethylene acrylate resins, an anhydride-modified ethylene vinyl acetate polymers, an anhydride-modified, high-density polyethylene resins, an anhydride-modified polypropylene resins, an acid/acrylate-modified ethylene vinyl acetate polymers in one embodiment; and mixtures of various anhydride-modified LLDPE resins.

In another general embodiment, the tie layer can include a polymer with a maleic anhydride (MAH)-grafted functionality. In a further embodiment, the MAH-graft level is from 0.05 wt % to 1.20 wt %, based on the weight of the MAH-grafted polymer. In a further embodiment, the MAH-graft level is from 0.07 wt % to 1.00 wt %, based on the weight of the MAH grafted polymer. In a further embodiment, the MAH-graft level is from 0.10 wt % to 0.60 wt %, based on the weight of the MAH-grafted polymer.

In one embodiment, the tie layer is a MAH-grafted ethylene-based polymer. In a further embodiment, the MAH-grafted ethylene-based polymer has a melt index (I2) from 0.5 g/10 min to 10 g/10 min in one embodiment and from 1 g/10 min to 6 g/10 min in another embodiment.

In another embodiment, the functionalized MAH-grafted ethylene-based polymer comprises at least one functional group selected from the following:

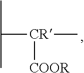

anhydride, and combinations thereof; and wherein R in the above chemical structure is hydrogen or an alkyl; and R′ is hydrogen or an alkyl.

In a further embodiment, each alkyl group, R and R′ of the above chemical structure, is independently, methyl, ethyl, propyl or butyl. In one embodiment, the functionalized ethylene-based polymer is selected from a functionalized ethylene homopolymer or a functionalized ethylene/alpha-olefin interpolymer. In a further embodiment, the functionalized ethylene-based polymer is a functionalized ethylene homopolymer. In another embodiment, the functionalized ethylene-based polymer is a functionalized ethylene/alpha-olefin interpolymer and, in still another embodiment, the functionalized ethylene-based polymer is a functionalized ethylene/alpha-olefin copolymer. The alpha-olefins may include from 3 carbon atoms to 8 carbon atoms (C3-C8) alpha-olefins in a preferred embodiment. For example, the alpha olefins include further propylene, 1-butene, 1-hexene, 1-octene and mixtures thereof.

In a preferred embodiment, the material of the tie layer can include, for example, commercially available compounds such as, NUCREL™; an ethylene vinyl acetate (EVA) polymer; BYNEL™; a modified ethylene acrylate resin; an anhydride-modified ethylene vinyl acetate polymer; an anhydride-modified, high-density polyethylene resin; an anhydride-modified polypropylene resin; an acid/acrylate-modified ethylene vinyl acetate polymers (available from The Dow Chemical Company); AMPLIFY™ TY (available from The Dow Chemical Company); and mixtures thereof. The BYNEL™ resin adheres to a variety of materials such as EVOH, polyamide, PE, ionomers, and ethylene copolymers. In particular, BYNEL™ 41E687 provides outstanding adhesion to ionomers.

All the above described materials for the layers, components (i)-(vii), have good transparency. For example, the layers are substantially transparent; and generally, have a transparency property of from 60% to 95% in one embodiment; from 70% to 95% in another embodiment; and from 80% to 95% in still another embodiment. The transparency property of the layers is measured according the procedure described in ASTM D-1003.

As aforementioned, the first transparent multilayer film member useful in the present invention may include any number of layers; and can be assembled in any desired combination of layers of one or more components (i)-(vii). In one embodiment, the first transparent multilayer film member can include, for example, the following five-layer structure using the commercial products described above: AFFINITY™ PL 1880G/BYNEL™ 41E687/EVOH E171B/BYNEL™ 41E687/NUCREL™ 0903HC.

In another embodiment, the first transparent multilayer film member can include, for example, the following six-layer structure using the commercial products described above: AFFINITY™ PL 1880G/BYNEL™ 41E687/EVOH E171B/BYNEL™ 41E687/ELITE™ AT 6101/NUCREL™ 0903HC.

In still another embodiment, the first transparent multilayer film member can include, for example, the following seven-layer structure using the commercial products described above: AFFINITY™ PL 1880G/BYNEL™ 41E687/EVOH E171B/BYNEL™ 41E687/ELITE™ AT 6101/BYNEL™ 41E687/NUCREL™ 0903HC.

The thickness of the first transparent film layer used in the present invention, can be generally from 50 μm to 200 μm in one embodiment; from 70 μm to 150 μm in another embodiment; and from 90 μm to 120 μm in still another embodiment. Thickness major relate with processing and appearance, not too critical with the performance.

The second transparent multilayer film member useful in the present invention may include any number of layers; and the number of layers of the second transparent multilayer film member can be identical to, or different from, the layers used to make the first transparent multilayer film member. For example, in a general embodiment the second multilayer film member comprises at least three layers including an inner layer, a core layer and an outer layer. In other embodiments, the second multilayer film member may include three or more layers in one embodiment, from 3 layers to 11 layers in another embodiment, from 3 layers to 7 layers in still another embodiment, from 3 layers to 6 layers in yet another embodiment, and from 3 layers to 5 layers in even still another embodiment.

In addition, the film substrates, components (i)-(vii), of the second transparent multilayer film member can be identical to, or different than, the layers of the first transparent multilayer film member. For example, the second transparent film member useful in the present invention may include film layers selected from one or more of the film layers described with reference to the first transparent multilayer film member. For example, in a preferred embodiment, the second transparent multilayer film member can include: (i) at least one low-seal initiation temperature inner layer for contacting a botanical matter; (ii) at least one outer bonding layer for contacting and bonding to an injection overmolded transparent plastic member; and (iii) at least one core barrier layer interposed between the inner and outer layer. In another embodiment, an optional tie layer or an adhesive layer can be added to each side surface of the core barrier layer to bind the three layers (i)-(iii) together forming at least a five-layer second transparent multilayer film member.

In still another preferred embodiment, the layers making up the second transparent multilayer film member includes an oxygen barrier layer and a separate moisture barrier layer, the two different barrier layers, the inner layer and the outer layer are bonded together with, for example, a tie layer disposed inbetween each of the four layers described above forming at least a seven-layer second transparent multilayer film member. For example, the seven-layered structure of the second transparent multilayer film member includes: (i) at least one low-seal initiation temperature inner layer for contacting a botanical matter; (ii) at least one oxygen barrier layer; (iii) at least a first tie layer interposed between the at least one low-seal initiation temperature inner layer and the at least one oxygen barrier layer; (iv) at least one moisture barrier layer; (v) at least a second tie layer interposed between the at least one oxygen barrier layer and the at least one moisture barrier layer; (vi) at least one outer bonding layer for contacting and bonding to the injection overmolded transparent plastic member; and (vii) at least a third tie layer interposed between the at least one moisture barrier layer and the at least one outer bonding layer.

The botanical matter used in the present invention is real. By the term “real”, with reference to a botanical matter, it is meant that the botanical matter is not a synthetic material, an artificial material, an imitation material, or a man-made item or article; but that the botanical matter is sourced from a living botanic material such as a plant, tree, or flower. In addition, the botanical matter is fresh. By the term “fresh”, with reference to a botanical matter, it is meant that the botanical matter is not dry, withered, rotten, or crumbled. A real and fresh botanical matter (or botanic item or material) typically has a moisture content of from about 80 wt % or more.

The real and fresh botanical matter used in the present invention to be encapsulated include, for example, plants, flowers, trees, tree leaves, branchlets, flower leaves, flower pedals, fruits, nuts, seeds, vegetables, shrubs, grass, vines, other growing plant life, and mixtures thereof.

Once the botanical matter is encapsulated in a transparent injection overmolded structure, the encapsulated botanical matter exhibits an extended shelf life. By the term “shelf life”, with reference to a botanical matter, it is meant that the botanic material shows no discoloration (fading) or dryness, i.e., no significant color change, after a period at least 30 days in one general embodiment; from at least 30 days to 2 years in another embodiment; from at least 30 days to 1 year in still another embodiment; and from at least 30 days to 6 months in yet another embodiment. The shelf life of the encapsulated botanical matter is determined by visual observation of the encapsulated botanical matter compared to a botanic material exposed to air.

Exemplary of the base member useful in the present invention include, for example, one or more of the following substrates: plastic, polymer, metal, wood, glass, and mixtures thereof. In a preferred embodiment, the base member includes, for example, a base member made of a transparent base member polymer ionomer. In another preferred embodiment, the material of the base member can include a substrate such as methacrylic acid, polyethylene, and mixtures thereof.

The thickness of the base member used in the present invention, can be any size and thickness desired. Generally, the thickness of the base member is greater than or equal to (≥) 2 mm in one embodiment; from 2 mm to 30 mm in another embodiment; and from 5 mm to 30 mm in still another embodiment. If the thickness of the base member is less than 2 mm, the botanical matter will be susceptible to damage.

In a preferred embodiment, the chemical bonding strength between the base member and the injection overmolded transparent plastic member should be as strong as possible to prevent potential delamination between the base member and the injection overmolded member. In general, the bonding strength of the outer bonding barrier layer is proper if an overmolded part exhibits no delamination between the base member to the overmold member after one month of storage at room temperature.

The injection overmold transparent plastic member may include, for example, an overmold member made of made of one or more of the following substrates: ionomers, polyolefins, co-polyesters, poly(methyl methacrylate), polycarbonate, and mixtures thereof.

Advantageously, the injection overmold transparent plastic member is substantially transparent and has a transparency property of from 70% to 95% in one embodiment; and from 85% to 95% in another embodiment. The transparency property of the injection overmold transparent plastic member is measured by the procedure described in ASTM D-1003.

The melt index of the injection overmold transparent plastic member is generally from 1 g/10 min to 50 g/10 min in one embodiment; and from 10 g/10 min to 50 g/10 min in another embodiment. The melt index property of the injection overmold transparent plastic member is measured by the procedure described in ASTM 1238 using 2,160 g and measured at a temperature of 190° C.

The thickness of the injection overmold transparent plastic member used in the present invention, can be from 1 mm to 15 mm in one general embodiment; from 1 mm to 10 mm in another embodiment; and from 2 mm to 4 mm in still another embodiment. When the thickness of the injection overmold transparent plastic member is below 1 mm, it is easy to damage the overmold member (e.g., the overmold member may fold or crease) and it is easy to damage the botanical matter by scratching/squeezing. And, when the thickness the injection overmold transparent plastic member is above 15 mm, it is easy to damage the botanical matter (e.g., the botanical matter may undergo discoloration) by overheating the botanical matter.

The transparent injection overmolded structure having a real botanical matter encapsulated in the transparent injection overmolded structure can also include other optional components such as an adhesive or glue material for binding or fixing the first transparent multilayer film member, component (a), and the botanical matter, component (c), onto the base member, component (d).

The adhesive or glue, optional component (f), is used to bond the first transparent multilayer film member, component (a), and the botanical matter, component (c), onto the base member, component (d). The adhesive or glue is made from, for example, poly(vinylidene chloride), acrylic acid, cyanoacrylate adhesive, and mixtures thereof.

The adhesion strength of the adhesive or glue is not critical since only a small proper strength is needed to fix the first transparent multilayer film member, component (a), and the botanical matter, component (c), onto the base member, component (d); and sufficient to be subjected to the overmold processing described herein. On the other hand, a good transparency of, for example >70% is important for providing the transparent injection overmolded structure with good appearance.

In another broad embodiment, the present invention provides an injection overmolding process for making the transparent injection overmolded structure for encapsulating a real botanical matter which includes, in general, the steps of:

Step (1) providing at least a first transparent multilayer film member and at least a second transparent multilayer film member; wherein the first and second multilayer film members have an oxygen and/or a moisture barrier function;

Step (2) encapsulating a real botanical matter inbetween the surface of the first transparent multilayer film member and the surface of the second transparent multilayer film member by using vacuum encapsulation to avoid air entrapment inbetween the first and second film members;

Step (3) fixing the encapsulated real botanical matter from step (2) onto the surface of a base member;

Step (4) placing the base with the real botanical matter from step (3) into an injection mold; and

Step (5) injection overmolding a transparent plastic onto the base from step (4) to encapsulate the real botanical matter inside the resultant molded part.

In a preferred embodiment, the first and second film members minimizes the real botanical matter from potential heat/scratch damage during step (5) of injection overmolding. In another preferred embodiment, the injection molding step (5) is carried out at a temperature of from 170° C. to 240° C. in one general embodiment; from 170° C. to 230° C. in another embodiment; and from 200° C. to 220° C. in still another embodiment. In other embodiments, the above fixing step (3) can be a hot stamping process or a glue process.

In another preferred embodiment of the present invention, the process for making an encapsulated product includes, for example, the following steps:

Step (1) providing at least a first transparent multilayer film member and at least a second transparent multilayer film member; wherein the first and second multilayer film members have an oxygen and/or a moisture barrier function;

Step (2) encapsulating a real botanical matter inbetween the two first and second transparent multilayer film members;

Step (3) fixing the encapsulated real botanical matter from step (2) onto the surface of a base member;

Step (4) placing the base with the encapsulated real botanical matter from step (3) into an injection mold; and

Step (5) overmolding a transparent plastic onto the base with the encapsulated real botanical matter from step (4) to encapsulate the base with the encapsulated real botanical matter.

If desired, the following optional step(s) can be used to make the encapsulated product: for example, one optional step includes: a process step (6) of subjecting the mold cavity to a vacuum to avoid air entrapment on the botanical matter during the overmolding step (5).

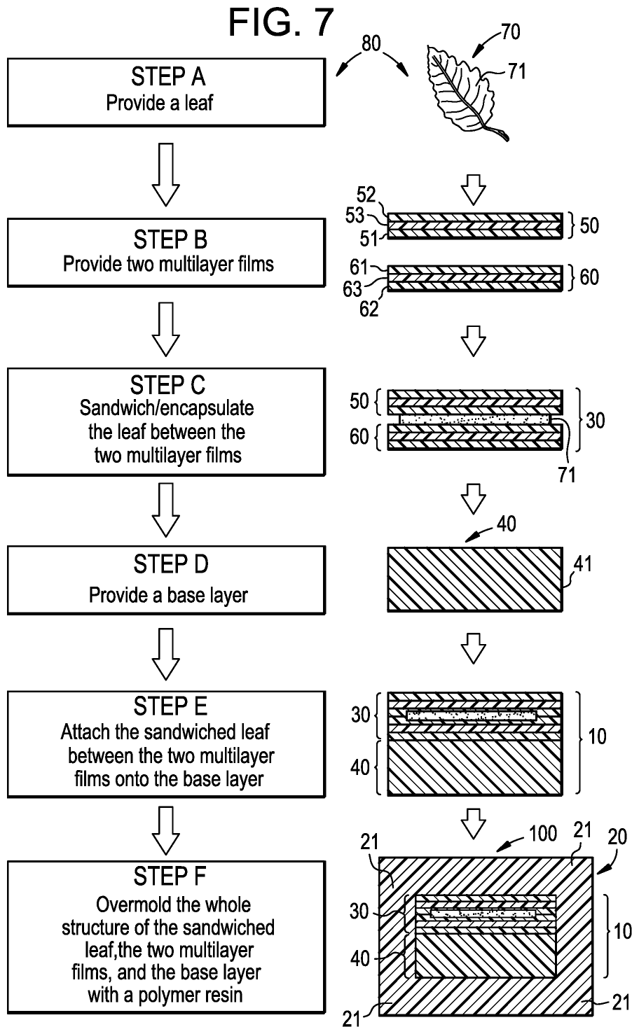

With reference to FIG. 7, there is shown still another preferred embodiment of an injection overmolding process, generally indicated by reference numeral 80, for encapsulating a real botanical matter of the present invention including, for example, the steps of:

Step (A): providing a real botanical matter such as a leaf;

Step (B): providing at least one first transparent multilayer film member; wherein the at least one first transparent multilayer barrier film member includes:

(i) at least one low-seal initiation temperature inner layer for contacting a botanical matter;

(ii) at least one outer bonding layer for contacting and bonding to an injection overmolded transparent plastic member; and

(iii) at least one core barrier layer interposed between the inner and outer layer; and

providing at least one second transparent multilayer film member; wherein the at least one second transparent multilayer barrier film member includes:

(i) at least one low-seal initiation temperature inner layer for contacting a botanical matter;

(ii) at least one outer bonding layer for contacting and bonding to an injection overmolded transparent plastic member; and

(iii) at least one core barrier layer interposed between the inner and outer layer;

(D) interposing, sandwiching and encapsulating the real botanical matter inbetween the surface of the at least one low-seal initiation temperature inner layer of the first transparent multilayer film member and the surface of the at least one low-seal initiation temperature inner layer of the second transparent multilayer film member such that the real botanical matter sandwiched inbetween the first transparent multilayer film member and the second transparent multilayer film member is encapsulated forming an integral transparent multilayered encapsulation structure;

(E) providing a base member for receiving and attaching to the transparent multilayered encapsulation structure of step (D); and attaching the transparent multilayered encapsulation structure of step (D) onto the surface of the base member of step (E);

(F) placing the transparent multilayered encapsulation structure attached to the surface of the base member of step (E) into an injection mold; and overmolding, by injection molding, a transparent plastic member onto the transparent multilayered encapsulation structure attached to the surface of the base member of step (E) positioned in the injection mold such that an overmolded transparent part encapsulating a real botanical matter inside the part is formed.

The process of the present invention may include at least one core barrier layer of the at least one first transparent multilayer film member and/or the at least one second transparent multilayer film member is an oxygen barrier layer, a moisture barrier layer, or both an oxygen barrier layer and a moisture barrier layer.

In another embodiment, the process may include at least one core barrier layer of the at least one first transparent multilayer film member and/or the at least one second transparent multilayer film member is an oxygen barrier layer having an oxygen barrier property in terms of oxygen transmittance rate of from 0.002 cc-mm/[m²-day] to 2 cc-mm/[m²-day].

In still another embodiment, the process may include at least one core barrier layer of the at least one first transparent multilayer film member and/or the at least one second transparent multilayer film member is a moisture barrier layer having an moisture barrier property in terms of moisture transmittance rate of from 0.1 gm-mm/[m²-day] to 10 gm-mm/[m²-day].

The process of the present invention may include further at least one tie layer in between the at least one first transparent multilayer film member and/or the at least one second transparent multilayer film member.

The process of the present invention may include an injection overmolded transparent plastic member made of an ionomer, poly(methyl methacrylate), co-polyesters, styrene-acrylonitrile, polystyrene, and mixtures thereof.

In another embodiment, the process may include a real botanical matter selected from the group consisting of a real plant, tree, leaf, flower, peddle, seed, and a combination thereof.

The process may include from at least three layers to at least seven layers to construct the at least one first transparent multilayer film member and/or the at least one second transparent multilayer film member.

In a preferred embodiment, the process of the present invention includes at least one first transparent multilayer film member and/or at least one second transparent multilayer film member comprising at least seven layers as follows: (i) at least one low-seal initiation temperature inner layer for contacting a botanical matter; (ii) at least one oxygen barrier layer; (iii) at least a first tie layer interposed between the at least one low-seal initiation temperature inner layer and the at least one oxygen barrier layer; (iv) at least one moisture barrier layer; (v) at least a second tie layer interposed between the at least one oxygen barrier layer and the at least one moisture barrier layer; (vi) at least one outer bonding layer for contacting and bonding to the injection overmolded transparent plastic member; and (vii) at least a third tie layer interposed between the at least one moisture barrier layer and the at least one outer bonding layer.

The present invention also can include an injection molded structure encapsulating a real botanical matter produced by the above process of the present invention.

In a preferred illustration of carrying out the process of the present invention, and not to be limited thereby, a real tree leaf or flower is encapsulated by using a plastic injection overmolding process. Firstly, real leaves or flowers are encapsulated in the middle of two films which have oxygen and moisture barrier function. The barrier film can avoid the fresh leaf/flower withered in short time and maintain an extended shelf life period for the product and the package of the product. And, the films can reduce potential heat/scratch damage on the fresh leaf/flower during the injection overmolding processing.

Secondly, the encapsulated real tree leaf or flower is fixed onto surface of a base by using hot stamping or glue or other processing. The base can be plastics, metal, wood or other materials by using molding or machining or other processing.

Then the real tree leaves, flowers decorated base is placed into an injection mold and an overmold transparent plastic is injected onto the base with the encapsulated real tree leaves or flowers fixed on the base and the resultant transparent structure including the encapsulated real tree leaves or flowers is inside the transparent part, as shown in FIGS. 1-7, which can be an ornamental product.

The encapsulation of a real leaf/flower includes pressing the real leaf/flower between two multilayer films. Each of the multilayer films used in the process have a low melting temperature inner layer (generally the closest layer to and contacting the leaf/flower), a barrier layer (e.g., EVOH), and a layer that capable of bonding to the overmold structure. The overmold structure is made, for example, from SURLYN™ resin (available from The Dow Chemical Company) which is a resin that provides high clarity to the resultant structure.

Some of the advantages or benefits of using the injection overmolding process of the present invention to make the resultant transparent injection overmolded structure with an encapsulated real botanical product; and the advantageous/beneficial properties exhibited by the resultant transparent injection overmolded structure having a real botanical matter encapsulated in the transparent injection overmolded structure produced according to the above-described process of the present invention can include, for example, using the process provides a resultant product that: (1) is a unique transparent decoration of a natural real botanical matter such as a leaf or flower petal as opposed to a fake or synthetic leaf or flower petal; (2) avoids ink/paint decoration environmental friendly without ink/paint usage, and (3) is natural and such a natural effect is extremely difficult to mimic by an artificial decoration.

The applications where the resultant transparent injection overmolded structure having a real botanical matter encapsulated in the transparent injection overmolded structure of the present invention, besides encapsulating real botanical matter, can also be used, for example, for packaging applications, and applications for manufacturing decorative parts.

### EXAMPLES

The following examples are presented to further illustrate the present invention in detail but are not to be construed as limiting the scope of the claims. Unless otherwise stated all parts and percentages are by weight.

Various terms and designations used in the Inventive Examples (Inv. Ex.) and the Comparative Examples (Comp. Ex.) which follow are explained hereinbelow:

“OTR” stands for oxygen transmittance rate.

“MTR” stands for moisture transmittance rate.

Various ingredients, components, additives, or raw materials used in the Inv. Ex. and the Comp. Ex. which follow are explained hereinbelow in Table I:

TABLE I
Raw Materials

| Material | Brief Description | Supplier |
|---|---|---|
| AFFINITY ™ | A polyolefin plastomer: a low-seal | The Dow |
| PL 1880G | initiation temperature inner layer (an | Chemical |
| | inner layer contacting a botanical | Company |
| | matter such as a leaf). | (Dow) |
| BYNEL ™ | An anhydride-modified, linear low- | Dow |
| 41E687 | density polyethylene; a tie layer. | |
| ELITE ™ | A linear low-density polyethylene | Dow |
| AT 6101 | (LLDPE): a moisture barrier layer. | |
| NUCREL ™ | An ethylene-methacrylic acid (EMAA) | Dow |
| 0903HC | copolymer resin: an outer bonding layer | |
| | (an outer layer contacting the overmold | |
| | material). | |
| SURLYN ™ | An ionomer: the overmold material. | Dow |
| PC2000 | | |
| SURLYN ™ | An ionomer: the overmold material. | Dow |
| PC2200 | | |
| FUSABOND ™ | An anhydride-modified, | Dow |
| N525 | ethylene copolymer | |

### Examples 1-3 and Comparative Example A—Production of Film Members

### Materials for Making Film Members

The materials used for producing the first and second multilayer film members numbered 1-3 and described in Table II were as follows:

AFFINITY™ is a low-seal initiation temperature inner layer which has a low melting temperature. EVOH is an oxygen barrier layer. ELITE™ AT PE is a moisture barrier layer. NUCREL™ is a tie layer for bonding to the overmolding material (e.g., SURLYN™) and for bonding other layers together.

### General Procedure for Making Film Members

The film members labeled “Film 1”, “Film 2” and “Film 3” (Inv. Ex. 1-3) described in Table II were produced by using a 7-layer blowing film processing machine known in the art. And, as described in Table II, the film member labeled “Film 0” did not include a barrier film layer.

TABLE II
Barrier Films

| Example | Film | | Thickness |
|---|---|---|---|
| No. | No. | Film Structure | (μm) |
| Comp. | Film | No barrier film is included in Film 0. | 0 |
| Ex. A | 0 | | |
| Inv. | Film | Film 1 includes the following | 90 |
| Ex. 1 | 1 | layers bonded together: | |
| | | (1) a low-seal initiation temperature | |
| | | inner layer contacting a botanic material | |
| | | (AFFINITY ™ PL 1880G 10 μm)/ | |
| | | (2) a tie layer (BYNEL ™ | |
| | | 41E687 10 μm)/ | |
| | | (3) an oxygen barrier layer | |
| | | (EVOH 10 μm)/ | |
| | | (4) a tie layer (BYNEL ™41E687 10 μm)/ | |
| | | (5) a moisture barrier layer (ELITE ™ | |
| | | AT 6101 30 μm)/ | |
| | | (6) an outer layer contacting overmold | |
| | | (NUCREL ™ 0903HC 20 μm) | |
| Inv. | Film | Film 2 includes the following | 90 |
| Ex. 2 | 2 | layers bonded together: | |
| | | (1) a low-seal initiation temperature inner | |
| | | layer contacting a botanic material | |
| | | (AFFINITY ™ PL 1880G + | |
| | | FUSABOND ™ N525 (95:5) 10 μm)/) | |
| | | (2) a tie layer (BYNEL ™41E687 10 μm)/ | |
| | | (3) an oxygen barrier layer | |
| | | (EVOH 10 μm)/ | |
| | | (4) a tie layer (BYNEL ™41E687 10 μm)/ | |
| | | (5) a moisture barrier layer (ELITE ™ | |
| | | AT 6101 30 μm)/ | |
| | | (6) an outer layer contacting overmold | |
| | | (NUCREL ™ 0903HC 20 μm) | |
| Inv. | Film | Film 3 includes the following | 50 |
| Ex. 3 | 3 | layers bonded together: | |
| | | (1) a low-seal initiation temperature | |
| | | inner layer contacting a botanic | |
| | | material (AFFINITY ™ PL | |
| | | 1880G 10 μm)/ | |
| | | (2) a tie layer (BYNEL ™41E687 10 μm)/ | |
| | | (3) an oxygen barrier layer | |
| | | (EVOH 10 μm)/ | |
| | | (4) a tie layer (BYNEL ™41E687 10 μm)/ | |
| | | (5) a moisture barrier layer | |
| | | (ELITE ™ AT 6101 30 μm)/ | |
| | | (6) an outer layer contacting overmold | |
| | | (NUCREL ™ 0903HC 10 μm) | |

General Procedure for Testing Film Members

The transparent injection overmold structures, used as barrier films, described above in Table II were tested as follows:

The OTR test measurements were obtained using the test procedure described in ASTM D3985-02. For the OTR measurements, the test instrument used was a MOCON OX-TRAN™ 2/21. The parameters for the OTR test were as follows: temperature=23.0° C., test area=50 cm², humidity 100% RH, and number of cycles=4.

The MTR test measurements were obtained using the test procedure described in ASTM F1249. The parameters for the MTR test were as follows: temperature=37.8° C. and humidity=100% RH.

The OTR testing conditions were as follows: the instrument used was a MOCON OX-TRAN™ 2/21; the parameters were as follows: the temperature was 23° C., the test area was 50 cm2, and the number of cycles was 4 cycles.

### Results of Testing Film Members

Table III describes the OTR and MTR results of the Inventive Examples and the Comparative Example.

TABLE III
Barrier Films Test Results

| Example | Film | OTR | MTR |
|---|---|---|---|
| No. | No. | (cc/[m²-day]) | (gm/[m²-day]) |
| Comp. | Film 0 | NM* | NM* |
| Ex. A | | | |
| Inv. Ex. 1 | Film 1 | 3.35 | 4.59 |
| Inv. Ex. 2 | Film 2 | 2.655 | 4.67 |
| Inv. Ex. 3 | Film 3 | 1.03 | 9.15 |

*“NM” stands for “not measurable”;
and OTR and MTR is not measured due to the transmission of either the oxygen or moisture for Film 0 (Comp. Ex. A) is 100%.

The results described in Table III show that the OTR and MTR performance of Films 1-3 (Inv. Ex. 1-3) are better than Film 0 (Comp. Ex. A). Since, Film 0 is without an added film layer, no data for OTR and MTR is described.

### Examples 4-6 and Comparative Example B—Production of Injection Overmold Structures Materials for Making Overmold Structures

The materials used for producing the transparent injection overmolded structure having a real botanical matter encapsulated in the transparent injection overmolded structure (herein “overmold structure”) were as follows:

The first and second multilayer film members numbered 1-3 that were used in Inv. Ex. 4-6 and Comp. Ex. B are described in Inv. Ex. 1-3 and Comp. Ex. A and in Table II.

The overmolding material used in these Examples is SURLYN™.

### General Procedure for Preparing Injection Overmold Structures

The injection overmolded structures produced for testing were prepared as follows:

Step (1) produced a transparent multilayer film AFFINITY™ PL 1880G 10 μm/BYNEL™ 41E687 10 μm/EVOH 10 μm/BYNEL™ 41E687 10 μm/ELITE™ AT 6101 30 μm/NUCREL™ 0903HC 20 μm for the first and second transparent multilayer film members; wherein the multilayer film members have an oxygen and a moisture barrier function;

Step (2) encapsulating a real botanical matter such as petal of a Bougainvillean flower, a leaf of Asparagus, and a leaf of Nandina and the like. inbetween the two transparent multilayer film members;

Step (3) fixing the encapsulated real botanical matter from step (2) onto the surface of a SURLYN™ PC2000 base member by using transparent acrylic acid glue;

Step (4) placing the base with the encapsulated real botanical matter from step (3) into an injection mold; and

Step (5) overmolding SURLYN™ PC2200 onto the base with the encapsulated real botanical matter from step (4) to encapsulate the base with the encapsulated real botanical matter.

Samples were molded using a Fanuc Roboshot S-2000i100BH injection molding machine with a 100 ton clamping force and 28 mm screw. The processing parameters of the overmolding step (5) above are described in Table IV.

TABLE IV

| | Screw | Screw | Screw |
|---|---|---|---|
| | Position 1 | Position 2 | Position 3 |
| Screw Position (mm) | 40 | 35 | 14 |
| Injection Speed | 25 | | |
| from Screw Position | | | |
| 1 to Screw Position 2 (mm/s) | | | |
| Injection Speed | 3 | | |
| from Screw Position | | | |
| 2 to Screw Position 3 (mm/s) | | | |
| Switch over pressure (MPa) | 350 | | |
| Holding speed (mm/s) | 10 | | |
| Cushion size (mm) | 5 | | |
| Holding time (s) | 0 | 5 | 15 |
| Holding pressure (MPa) | 350 | 450 | 450 |

| | |
|---|---|
| Barrel temperatures | Zone1 = 40; Zone 2 = 150; |
| (degrees Celsius) | Zone 3 = 160; Zone 4 = 180; |
| | Zone 5 = 200; Zone 6 = 210; Zone 7 = |
| | 210; Zone 8 = 210; Zone 9 = 210 |
| Screw speed (m/min) | 4 |
| Back pressure (MPa) | 1 |
| Suck back distance (mm) | 2 |
| Suck back speed (mm/s) | 5 |
| Total cycle time (s) | 58 |
| Injection time (s) | 6.4 |
| Metering time (s) | 9 |
| Metering delay (s) | 0 |
| Cooling time (s) | 20 |
| Mold temperature | 25 |
| (degrees Celsius) | |

### General Procedure for Testing Injection Overmold Structures

Aging tests were performed on the final overmold structures to evaluate lamination between overmolding outer layer and the botanical matter, and compared discolor and withering of the botanical matter before and after aging, the aging conditions used were: 55° C. for 4 hr, 23° C. for 4 hr, and −23° C. for 4 hr; and thereafter, the aging conditions were continued for a total of 48 hr.

### Results of Testing Overmold Structures

The results of the above aging tests of the injection overmold structures indicated that: (1) no delamination between the overmolding outer layer and the botanical matter occurred when a specific outer layer was selected for the bonding layer; (2) the botanical matter showed no signs of discoloration or withering when the films with barrier films protection were used; and (3) the botanical matter without barrier films protection had discolor and withering issues.

What is claimed is:

1. A transparent injection overmolded structure encapsulating a real botanical matter comprising:
(a) at least one first transparent multilayer film member; wherein the at least one first transparent multilayer barrier film member includes:
(i) at least one low-seal initiation temperature inner layer for contacting a botanical matter;
(ii) at least one outer bonding layer for contacting and bonding to an injection overmolded transparent plastic member; and
(iii) at least one core barrier layer interposed between the inner layer and the outer layer;
(b) at least one second transparent multilayer film member; wherein the at least one second transparent multilayer barrier film member includes:
(i) at least one low-seal initiation temperature inner layer for contacting a botanical matter;
(ii) at least one outer bonding layer for contacting and bonding to an injection overmolded transparent plastic member; and
(iii) at least one core barrier layer interposed between the inner inlayer and the outer layer;
(c) a real botanical matter disposed and sandwiched inbetween the surface of the at least one low-seal initiation temperature inner layer of the first transparent multilayer film member and the surface of the at least one low-seal initiation temperature inner layer of the second transparent multilayer film member forming an integral transparent multilayered encapsulation structure;
(d) a base member for receiving and attaching to the transparent multilayered encapsulation structure of component (c); and
(e) an injection overmolded transparent plastic member integral with, and enveloping, the base member of component (d) and the transparent multilayered encapsulation structure of component (c) to form an overmolded transparent part encapsulating a real botanical matter inside the part.

2. The overmolded structure of claim 1, wherein the at least one core barrier layer of the at least one first transparent multilayer film member and/or the at least one core barrier layer of the at least one second transparent multilayer film member is an oxygen barrier layer, a moisture barrier layer, or both an oxygen barrier layer and a moisture barrier layer.

3. The overmolded structure of claim 1, wherein the at least one core barrier layer of the at least one first transparent multilayer film member and/or the at least one core barrier layer of the at least one second transparent multilayer film member is an oxygen barrier layer having an oxygen barrier property in terms of oxygen transmittance rate of from 0.002 cc-mm/[m²-day] to 2 cc-mm/[m²-day].

4. The overmolded structure of claim 1, wherein the at least one core barrier layer of the at least one first transparent multilayer film member and/or the at least one core barrier layer of the at least one second transparent multilayer film member is a moisture barrier layer having an moisture barrier property in terms of moisture transmittance rate of from 0.1 gm-mm/[m²-day] to 10 gm-mm/[m²-day].

5. The overmolded structure of claim 1, wherein the at least one first transparent multilayer film member and/or the at least one second transparent multilayer film member includes further at least one tie layer.

6. The overmolded structure of claim 1, wherein the injection overmolded transparent plastic member is made of an ionomer, poly(methyl methacrylate), co-polyesters, styrene-acrylonitrile, polystyrene, and mixtures thereof.

7. The overmolded structure of claim 1, wherein the real botanical matter is selected from the group consisting of a real plant, a tree, a leaf, a flower, a peddle, a seed, and a combination thereof.

8. The overmolded structure of claim 1, wherein the at least one first transparent multilayer film member and/or the at least one second transparent multilayer film member comprises from at least three layers to at least seven layers.

9. The overmolded structure of claim 1, wherein the at least one first transparent multilayer film member and/or the at least one second transparent multilayer film member comprises at least seven layers and wherein the at least seven layers comprise layers of:
(i) at least one low-seal initiation temperature inner layer for contacting a botanical matter;
(ii) at least one oxygen barrier layer;
(iii) at least a first tie layer interposed between the at least one low-seal initiation temperature inner layer and the at least one oxygen barrier layer;
(iv) at least one moisture barrier layer;
(v) at least a second tie layer interposed between the at least one oxygen barrier layer and the at least one moisture barrier layer;
(vi) at least one outer bonding layer for contacting and bonding to the injection overmolded transparent plastic member; and
(vii) at least a third tie layer interposed between the at least one moisture barrier layer and the at least one outer bonding layer.

10. An injection overmolding process for encapsulating botanical matter comprising the steps of:
(A) providing a real botanical matter;
(B) providing at least one first transparent multilayer film member; wherein the at least one first transparent multilayer barrier film member includes:
(i) at least one low-seal initiation temperature inner layer for contacting the botanical matter;
(ii) at least one outer bonding layer for contacting and bonding to an injection overmolded transparent plastic member; and
(iii) at least one core barrier layer interposed between the inner layer and the outer layer;
(C) providing at least one second transparent multilayer film member; wherein the at least one second transparent multilayer barrier film member includes:
(i) at least one low-seal initiation temperature inner layer for contacting the botanical matter;
(ii) at least one outer bonding layer for contacting and bonding to an injection overmolded transparent plastic member; and
(iii) at least one core barrier layer interposed between the inner layer and the outer layer;
(D) interposing and sandwiching the real botanical matter inbetween the surface of the at least one low-seal initiation temperature inner layer of the first transparent multilayer film member and the surface of the at least one low-seal initiation temperature inner layer of the second transparent multilayer film member;
(E) encapsulating the real botanical matter sandwiched inbetween the first transparent multilayer film member and the second transparent multilayer film member forming an integral transparent multilayered encapsulation structure;
(F) providing a base member for receiving and attaching to the transparent multilayered encapsulation structure of step (E);
(G) attaching the transparent multilayered encapsulation structure of step (E) onto the surface of the base member of step (F);
(H) placing the combination of the transparent multilayered encapsulation structure attached to the surface of the base member of step (G) into an injection mold; and
(I) overmolding, by injection molding, a transparent plastic member onto the combination of the base member and the transparent multilayered encapsulation structure attached to the surface of the base member positioned in the injection mold of step (H) to form an overmolded transparent part encapsulating a real botanical matter inside the part.

11. An injection molded structure encapsulating a real botanical matter produced by the process of claim 10.
